(19) United States
(12) Patent Application Publication
(10) Pub. No.: US 2008/0020147 A1
(43) Pub. Date: Jan. 24, 2008

(54) Method and Apparatus for the Application of Powder Material to Substrates

(75) Inventors: Simon Tullett, Great Cambourne (GB); Adrian Jarvis, St Neots (GB); David Billington, Rushden (GB); Russell King, Brampton Cambs (GB); David Gledhill, Dry Barton (GB); Paul Willshire, London (GB); Tom Willsher, London (GB); Michael John Holroyd, Great Shelford (GB)

Correspondence Address: BUCHANAN, INGERSOLL & ROONEY PC, POST OFFICE BOX 1404, ALEXANDRIA, VA, 22313-1404, US

(73) Assignee: Phoqus Pharmaceuticals Limited, West Malling (GB)

(21) Appl. No.: 10/585,142

(22) PCT Filed: Dec. 30, 2004
(86) PCT No.: PCT/GB04/05458

§ 371 Date: Jun. 8, 2007

(30) Foreign Application Priority Data
Dec. 30, 2003 (GB) 0330171.0

(51) Int. Cl. A61J 3/00; B05B 5/08

(52) U.S. Cl. 427/474; 118/621

(57) ABSTRACT

Apparatuses (201) and methods for electrostatically applying a powder material to substrates are described. A plurality of platens (202, 203) are provided, each arranged to hold a plurality of substrates such as solid dosage forms (101, 111). Each platen (202, 203) is driven around an endless path and passes through a loading region (FIGS. 3, 4) in which substrates are loaded onto the platens (202, 203), a developing region (FIGS. 5, 6) in which the powder material is applied to the substrates, a fusing region (FIG. 7) in which the applied powder material is fused, and an unloading region (FIG. 8) in which substrates are removed from the platens (202, 203).

The present invention relates to a method and apparatus for the application of powder material to substrates. The invention relates more particularly, but not exclusively, to the electrostatic application of powder material to solid dosage forms.

A “solid dosage form” can be formed from any solid material that can be apportioned into individual units and is, therefore, a unit dose form. A solid dosage form may be, but is not necessarily, an oral dosage form. Examples of pharmaceutical solid dosage forms include pharmaceutical tablets and other pharmaceutical products that are to be taken orally, including pellets, capsules and spherules, and pharmaceutical pessaries, pharmaceutical bougies and pharmaceutical suppositories. Pharmaceutical solid dosage forms can be formed from pharmaceutical substrates that are divided into unit dose forms. Examples of non-pharmaceutical solid dosage forms include items of confectionery, washing detergent tablets, repellents, herbicides, pesticides and fertilisers.

The electrostatic application of powder material to solid dosage forms is known. Examples of patent specifications describing such applications are WO 96/35516 and WO 02/49771.

When coating solid dosage forms electrostatically with powder it is desirable to position each solid dosage form appropriately in relation to the powder applicator and that requires individual handling of each solid dosage form. Also, if powder is to be applied to opposite faces of the solid dosage form while it is held in a desired position it becomes desirable to be able to turn over the solid dosage form during the handling of it. On a laboratory scale, such handling of the solid dosage forms presents little problem, but if it is desired to apply powder to solid dosage forms at a reasonably high rate, as required for industrial production, the handling of the solid dosage forms becomes a problem.

In WO 96/35516 solid dosage forms are held on a first rotary drum for coating a face of the solid dosage form and are then transferred onto a second rotary drum for coating an opposite face. Such a method has proved workable but there are losses in production, especially in connection with the loading and unloading of solid dosage forms onto and from the drums, and the transfer of solid dosage forms from one drum to another. There is also a limit to the path length (the circumference of the drum) available for treatment of a face of the solid dosage form and the system is not particularly flexible and cannot therefore easily be adapted from a set up for treating one solid dosage form according to one set of requirements to a set up for treating another solid dosage form according to another set of requirements.

In the applicant's co-pending application no GB 0314188.4, this problem is solved by using platens to convey the substrates. The substrates are placed onto each platen, the platens are conveyed around a path and the substrates are electrostatically coated with powder material. The platen may then be inverted and the substrates transferred to a second platen, on which the substrates are coated on their other side with powder material. The platen is then removed from the path and the substrates are removed from the platen. Whilst this method has proved to be very successful, since each substrate is maintained in the platen and is not individually handled, there are nonetheless problems associated with this method. There are losses in production in connection with the loading and unloading of the platens onto and from the path. In addition, as the platens are separable from the path, great care must be taken that the platen dimensions and registration onto the path is correct so that the distance between the substrates and the source of powder material in the developer may be accurately controlled.

It is an object of the invention to provide an improved method and apparatus for the application of powder material to substrates.

According to a first aspect of the invention there is provided an apparatus for electrostatically applying a powder material to substrates, the apparatus comprising:
a plurality of platens arranged to move along an endless path, each platen being arranged to hold a plurality of substrates;
driving means for driving the platens along the endless path; and
an applicator assembly for applying the powder material to the substrates, the applicator assembly being located on a part of the endless path.

In one form of the invention, said plurality of platens are fixed to move along the endless path.

According to the first aspect of the invention, the plurality of platens are each attached to, and are moved around, the endless path. In the normal use of the apparatus, the platens are not removed from the endless path. Process stations, such as the applicator assembly, can readily be incorporated into the apparatus. Further, the dimensions of the endless path can be varied to suit the process stations used. Thus, the apparatus is extremely flexible.

In one embodiment, the applicator assembly comprises at least one applicator having a supply of powder material and charging means for electrostatically charging the powder material.

Preferably, a portion of the applicator is replaceable by a user, the replaceable portion including the supply of powder material.

Advantageously, the apparatus further includes a fusing assembly for fusing powder material electrostatically applied to the substrates, the fusing assembly being located on a part of the endless path. In one embodiment, the fusing assembly comprises a plurality of fusing devices disposed in series along the endless path.

The fusing may be carried out with infra-red radiation, characterised in that the wavelength of the radiation used corresponds to a significant peak present in the infra-red spectrum of the powder material but not present to any significant extent in the infra-red spectrum of the substrate.

Preferably, the apparatus further includes a loading station for loading substrates onto the platens. Preferably, the apparatus further includes an unloading station for removing substrates from the platens.

In one embodiment, the apparatus further includes a transfer station for transferring the substrates between platens. This is useful when both sides of the substrates need to be coated with powder material. The first side may be coated in a first platen, then the substrates may be transferred to a second platen and the second side of the substrates may be coated in the second platen.

Preferably, the apparatus further includes at least one detector for inspecting the platens. The detector may be arranged to detect when a substrate is missing from a given position on a platen or to detect when a substrate is present at a given position on a platen.

In one form of the invention, the at least one detector comprises a camera. The camera may be associated with a light source such that light is directed towards the platen so that, for any given position on a platen that does not contain a substrate, light is reflected from that position and is detected by the camera.

In an alternative form of the invention, the at least one detector comprises a plurality of optic fibres. The at least one detector may be arranged to detect a variety of colours.

Preferably the at least one detector is remotely operable. The detector may be arranged to provide a signal to a user.

In one embodiment, the driving means is arranged to drive the platens along the endless path at a plurality of speeds. By allowing each platen to move at a different speed from its neighbouring platen, while on the same endless path, the efficiency of the coating process is greatly improved.

In one embodiment, each of said platens is independently drivable by said driving means.

A remote controller may also be provided to control the motion of the said platens. The remote controller may communicate with one or more of said platens via a wireless link, for example using the Bluetooth™ standard.

In a preferred embodiment, the endless path is substantially horizontal.

In the case where the endless path is horizontal, the apparatus preferably includes a vertical partition separating the driving means from the platens, the driving means being located in a non-product region and the platens being located in a product region. The apparatus may further include a second vertical partition separating the non-product region from the product region, the first and second vertical partitions defining a substantially annular chamber between the non-product region and the product region. The substantially annular chamber may include an air flow in the vertical direction.

Separating the product region and non-product region is advantageous in two respects. Firstly, the substrates are less likely to become contaminated as they are separated from the mechanics of the system. This is particularly important in a pharmaceutical context. Secondly, the drive means is less likely to become dirty with excess powder material and this reduces costs of replacement and repairs.

Advantageously, the platens are fixed or arranged to move along the endless path in pairs, one of the platens in the pair being located above the other platen in the pair. In that case, the platens in each pair may be movable with respect to one another in the vertical direction. Preferably, the platens are rotatably mounted. In one embodiment, the upper platen is located directly above the lower platen and the platens are fixed in the horizontal direction although are free to move in the vertical direction. It should be noted that the transfer of solid dosage forms can be made more reliable by circulating platens in pairs.

In the case where the platens are fixed or arranged to move along the endless path in pairs, the applicator assembly for applying the powder material to the substrates comprises at least one upper applicator for applying the powder material to substrates in the upper platen and at least one lower applicator for applying the powder material to substrates in the lower platen.

The upper and lower applicators may be arranged to supply powder material to the substrates substantially simultaneously. Alternatively, the upper and lower applicators may be arranged to supply powder material to the substrates sequentially.

In the case where the platens are fixed or arranged to move along the endless path in pairs, the apparatus may further include a fusing assembly comprising an upper fuser for fusing powder material electrostatically applied to the substrates in the upper platen and a lower fuser for fusing powder material electrostatically applied to the substrates in the lower platen.

Advantageously, the upper and lower fusers are arranged to fuse powder material on the substrates substantially simultaneously. This is particularly advantageous as the fusing step is often the limiting time factor on the process. Therefore, if the powder material on substrates in two platens can be fused simultaneously, this will improve the efficiency of the coating process.

In the case where the platens are fixed or arranged to move along the endless path in pairs, the apparatus may further include a transfer station for transferring substrates from the upper platen to the lower platen.

The transfer station may be arranged to move the platens relative to one another in the vertical direction such that a face of the lower platen is adjacent a face of the upper platen, the face of the upper platen holding a plurality of substrates, to shift the plurality of substrates from the face of the upper platen to the adjacent face of the lower platen and to separate the adjacent faces of the upper and lower platens.

Preferably, the transfer station includes at least one vibrator for vibrating one or both platens. Vibrating one or both platens ensures that all the substrates are successfully transferred between the platens.

In one form of the invention, powder is applied to a first portion of the substrates when said substrates are in the upper platen and powder is applied to a second portion of the substrates when said substrates are in the lower platen, said second portion being on the opposite side of said substrates to said first portion.

According to the first aspect of the invention, there is also provided a method for electrostatically applying a powder material to substrates, the method comprising the steps of:
providing a plurality of platens arranged to move along an endless path, each platen being arranged to hold a plurality of substrates;
placing the substrates on the platens;
driving the platens in series along an endless path; and
electrostatically applying a powder material to the substrates on the platens.

In one form of the invention, the plurality of platens are fixed to move along the endless path.

In one embodiment, the step of electrostatically applying a powder material comprises driving the platens past at least one applicator having a supply of powder and charging means for electrostatically charging the powder material.

Preferably, the method further comprises the step of fusing the powder material after it is electrostatically applied. In one embodiment, the step of fusing comprises driving the platens past a plurality of fusing devices disposed in series along the endless path.

Preferably, the method further comprises the step of removing the substrates from the platens after the powder material has been electrostatically applied.

Preferably, the method further comprises the step of transferring the substrates between platens. The step of transferring the substrates between platens may comprise vibrating one or both platens. In the form of the invention in which the platens are fixed or arranged to move along the endless path in pairs, one of the platens in the pair may be located above the other platen in the pair. Furthermore, the substrates may be transferred from the upper platen to the lower platen.

In a preferred embodiment, the method further comprises the step of inspecting the substrates in the platens. The step of inspecting the substrates in the platens is preferably carried out by at least one detector for inspecting the platens. In one form of the invention, the at least one detector comprises a camera. The camera may be associated with a light source such that light is directed towards the platen so that, for any given position on a platen that does not contain a substrate, light is reflected from that position and is detected by the camera. In another form of the invention, the at least one detector comprises a plurality of optic fibres. The at least one detector may be arranged to detect a variety of colours. Preferably the at least one detector is remotely operable. The detector may be arranged to provide a signal to a user.

In one embodiment, the step of driving the platens along the endless path comprises driving the platens simultaneously at a plurality of speeds.

In one embodiment, each of said platens is independently drivable by said driving means.

A remote controller may also be provided to control the motion of the said platens. The remote controller may communicate with at least some of said platens via a wireless link, for example using the Bluetooth™ standard.

The endless path along which the platens are driven is preferably substantially horizontal.

The substrates may be pharmaceutical substrates. The substrates may be solid dosage forms. The substrates may be cores of pharmaceutical tablets.

According to the first aspect of the invention, there is also provided an apparatus as previously described for carrying out the method previously described.

According to a second aspect of the invention, there is provided a method of electrostatically applying a powder material to opposite faces of each of a plurality of substrates, the method comprising the steps of:
providing an upper platen and a lower platen, the upper platen being located vertically above the lower platen, each platen being arranged to hold a plurality of substrates;
providing a plurality of substrates on the upper face of the upper platen;
electrostatically applying powder material to exposed first faces of each of the plurality of substrates on the upper platen;
rotating the upper platen so that the plurality of substrates is located on the lower face of the upper platen;
moving the platens relative to one another in the vertical direction such that the upper face of the lower platen is adjacent the lower face of the upper platen;
shifting the plurality of substrates from the lower face of the upper platen to the upper face of the lower platen;
separating the adjacent faces of the upper and lower platens; and
electrostatically applying powder material to exposed second faces of each of the plurality of substrates on the lower platen.

Preferably, the step of shifting the plurality of substrates from the lower face of the upper platen to the upper face of the lower platen includes vibrating one or both platens.

According to the second aspect of the invention, there is also provided an apparatus for electrostatically applying a powder material to substrates, the apparatus comprising:
a plurality of pairs of platens arranged for movement about an endless horizontal path, each pair of platens comprising a lower platen and an upper platen located vertically above the lower platen, each platen being arranged to hold a plurality of substrates;
an applicator assembly for applying the powder material to the substrates, the applicator assembly being located on a part of the endless path; and
a transfer station for moving the platens relative to one another in the vertical direction such that the upper face of the lower platen is adjacent the lower face of the upper platen, the lower face of the upper platen holding a plurality of substrates, for shifting the plurality of substrates from the lower face of the upper platen to the upper face of the lower platen and for separating the adjacent faces of the upper and lower platens.

In one embodiment of the invention, the plurality of pairs of platens are fixed for movement about the endless horizontal path.

The transfer station preferably comprises a vibrator for vibrating the upper and/or lower platens.

Preferably, the applicator assembly comprises at least one upper applicator for applying the powder material to substrates in the upper platen and at least one lower applicator for applying the powder material to substrates in the lower platen.

In one embodiment of the invention, a kinematic mounting arrangement is provided between upper and lower platens to accurately control the position of the upper and lower platens relative to one another when the plurality of substrates are shifted from the lower face of the upper platen to the upper face of the lower platen.

According to a third aspect of the invention, there is provided an apparatus for electrostatically applying a powder material to substrates, the apparatus comprising:
a plurality of platens arranged to move along an endless path, each platen being arranged to hold a plurality of substrates;
an applicator assembly located on a part of the endless path for applying the powder material to substrates; and
driving means for driving the platens along the endless path, the driving means being arranged to drive platens simultaneously at a variety of speeds.

In one embodiment of the invention, the plurality of platens are fixed to move along the endless path.

According to the third aspect of the invention, there is also provided a method for electrostatically applying a powder material to substrates, the method comprising the steps of:
providing a plurality of platens arranged to move along an endless path, each platen being arranged to hold a plurality of substrates;
placing the substrates on the platens;
driving the platens in series along an endless path, each platen being independently driveable at a variety of speeds; and
electrostatically applying the powder material to the substrates on the platens.

In one embodiment of the invention, the plurality of platens are fixed to move along the endless path.

In one embodiment, each of said platens is independently drivable by said driving means.

A remote controller may also be provided to control the motion of the said platens. The remote controller may communicate with at least some of said platens via a wireless link, for example using the Bluetooth™ standard.

According to a fourth aspect of the present invention, there is provided an apparatus for electrostatically applying a powder material to substrates, the apparatus comprising:
a plurality of platens arranged to move along an endless path, each platen being arranged to hold a plurality of substrates;
an applicator assembly located on a part of the endless path for applying the powder material to substrates; and
driving means for driving the platens along the endless path, wherein each of said platens is independently drivable by said driving means.

Each platen may have its own prime means for driving it along the endless path.

In one embodiment of the invention, the plurality of platens are fixed to move along the endless path.

According to the fourth aspect of the invention, there is also provided a method for electrostatically applying a powder material to substrates, the method comprising the steps of:
providing a plurality of platens arranged to move along an endless path, each platen being arranged to hold a plurality of substrates;
placing the substrates on the platens;
driving the platens in series along an endless path, each platen being independently driveable by said driving means; and
electrostatically applying the powder material to the substrates on the platens.

In one embodiment of the invention, the plurality of platens are fixed to move along the endless path.

The fourth aspect of the invention provides a particularly flexible arrangement in which the process steps can be readily redesigned. For example, additional process steps may be included and/or the implementation of existing process steps can be altered.

A remote controller may also be provided to control the motion of the said platens. The remote controller may communicate with one or more of said platens via a wireless link, for example using the Bluetooth™ standard.

According to a fifth aspect of the invention, there is provided a carriage for conveying substrates along a path, the carriage comprising:
an upper platen for holding a plurality of substrates;
a lower platen for holding a plurality of substrates;
a bracket for supporting the upper and lower platen, the upper and lower platen being rotatably mounted on the bracket and being movable vertically with respect to one another; and
driving means for driving the carriage along the path.

In one embodiment, when the substrates are conveyed along the path by the carriage, the vertical separation of the upper platen and the lower platen is substantially preselected by a user, but the upper platen and/or the lower platen are free to move a small amount in the vertical direction. Allowing the upper and/or lower platens to move a small amount in the vertical direction allows the distance between an applicator for applying powder material to the substrates and the substrates themselves to be easily controlled and adjusted.

In one embodiment of the invention, a kinematic mounting arrangement is provided between the upper and lower platens, such that, on moving the upper and lower platens so that they are adjacent to one another, the relative positions of the upper and lower platens are accurately controllable.

According to a sixth aspect of the invention, there is provided an apparatus for electrostatically applying a powder material to substrates, the apparatus comprising:
a product region comprising a plurality of platens arranged to move along an endless path, each platen being arranged to hold a plurality of substrates and an applicator assembly located on a part of the endless path for applying the powder material to substrates;
a non-product region comprising driving means for driving the platens along the endless path; and
a partition separating the product region and the non-product region.

In one embodiment of the invention, the plurality of platens are fixed to move along the endless path.

Preferably, the apparatus further comprises a second partition separating the product region and the non-product region, the two partitions defining an insulating chamber.

The insulating chamber may include an air flow in a direction substantially parallel to the partitions. The airflow acts to remove any particles in the annular chamber. This provides a high level of isolation of the product and non-product regions.

In one embodiment, the endless path is substantially horizontal and the partition or partitions is/are substantially vertical.

According to a seventh aspect of the invention, there is provided a method for fusing a powder coating on a substrate, in which fusing is carried out with infra-red radiation, characterised in that the wavelength of the radiation used corresponds to a significant peak present in the infra-red spectrum of the coating material but not present to any significant extent in the infra-red spectrum of the substrate.

According to the seventh aspect of the invention, there is also provided an apparatus for fusing powder coating on a substrate, in which the apparatus is arranged to carry out the fusing with infra-red radiation, characterised in that the wavelength of the radiation used corresponds to a significant peak present in the infra-red spectrum of the coating material but not present to any significant extent in the infra-red spectrum of the substrate.

According to an eighth aspect of the invention, there is provided a platen arranged to hold a plurality of substrates, the platen comprising:
a vacuum chamber for connection of the platen to a vacuum source;
an electrically conducting substrate mount having a plurality of hollows each suitable for receiving one of said plurality of substrates, wherein said substrate mount has a plurality of passageways therethrough, each passageway connecting one of said plurality of hollows to said vacuum chamber;
an electrically conducting shield having a plurality of holes aligned with the hollows in said substrate mount; and
an electrical insulator, positioned to electrically insulate said shield from said substrate mount, wherein, in the use of the platen, said electrical insulator electrically insulates said shield from said plurality of substrates.

The platen preferably includes a tool plate located between said vacuum chamber and said substrate mount said tool plate having a plurality of passageways therethrough aligned with the passageways of said substrate mount. The tool plate may be an aluminium tool plate. The tool plate provides a reliably flat surface on which to mount the substrates, indeed the term tool plate should be understood as referring to any plate that provides a suitably flat surface.

In one form of the invention, the shield is a gold-plated stainless steel shield.

A filter mount may be interposed between the platen and the vacuum source.

In one form of the invention, the platen is connected to a vacuum source via a carriage arm having a vacuum pipe therein.

An upper and lower platen may be constructed as described above, with each platen being connected via the carriage arm.

The electrical insulator may comprise a plurality of rings and separate hollows. In one form of the invention the electrical insulator comprises a plurality of insulating washers, however, other forms are possible, such as a sheet of electrically insulating material having a number of holes aligned with the hollows of the substrate mount.

It will be understood that any features of the invention described in relation to one aspect of the invention may also be introduced into another aspect of the invention.

An embodiment of the invention will now be described with reference to the accompanying drawings of which

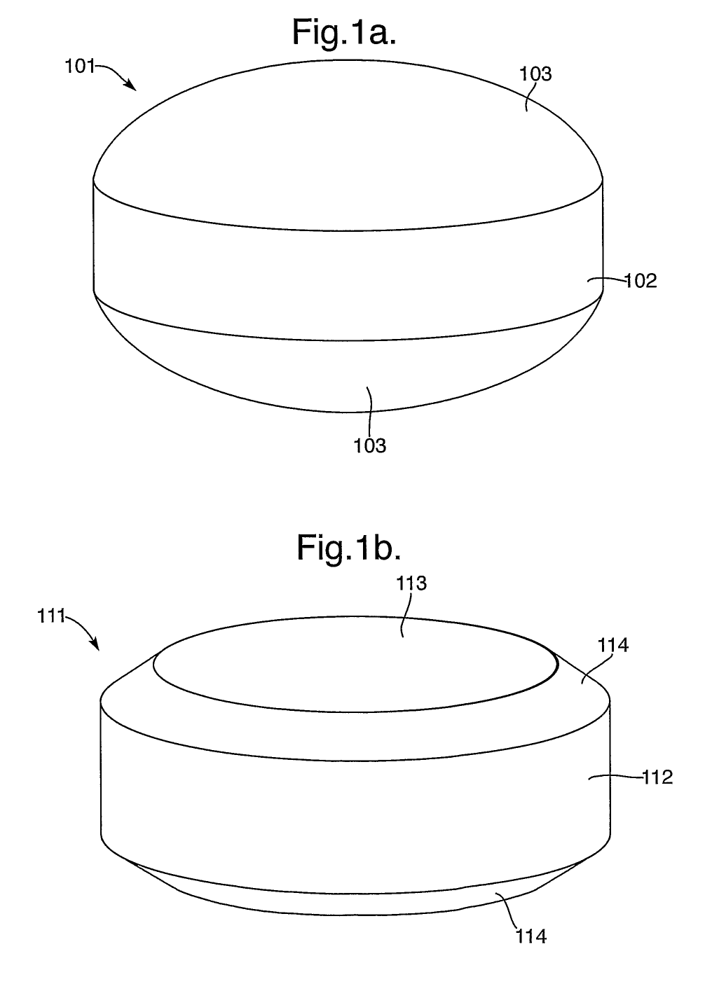

FIG. 1a is a perspective view of a first solid dosage form to be coated;

FIG. 1b is a perspective view of a second solid dosage form to be coated;

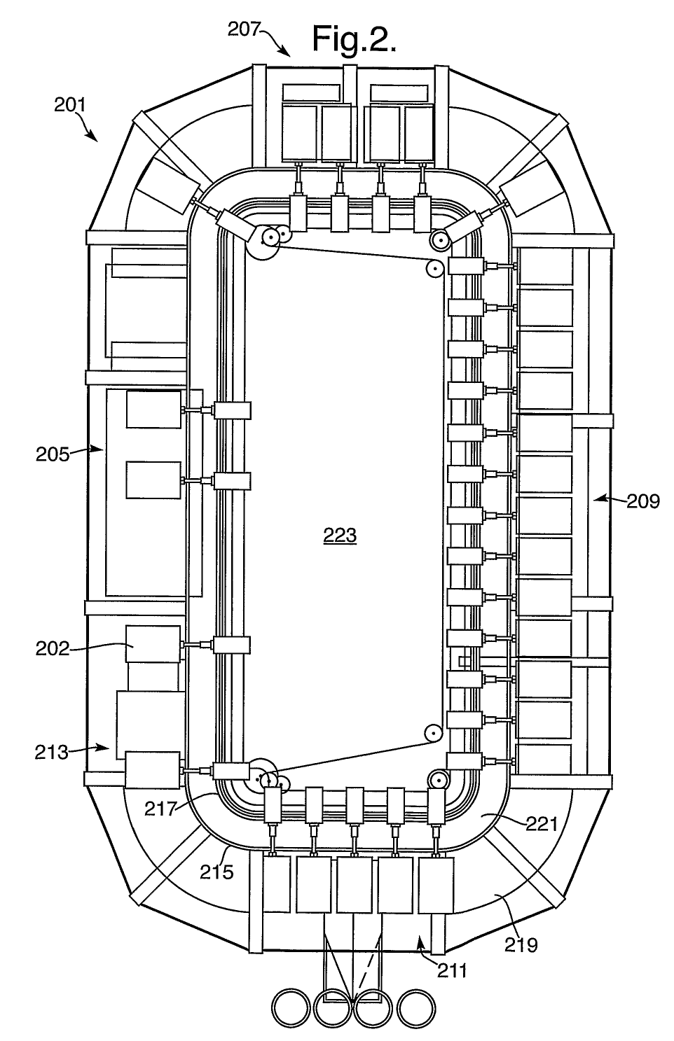

FIG. 2 is a schematic plan view of the coating apparatus;

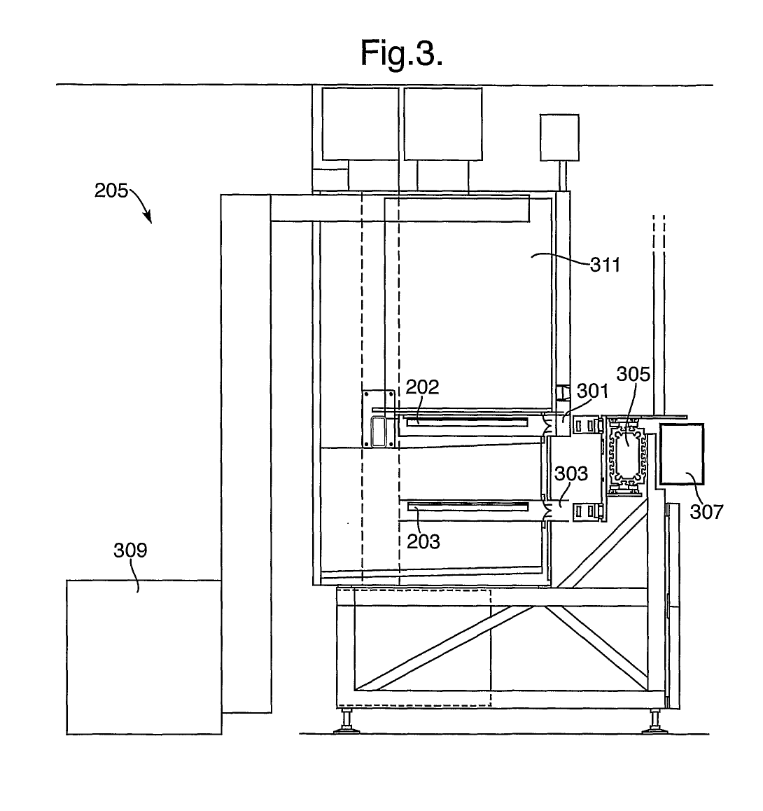

FIG. 3 is a sectional view of the loading region of the apparatus of FIG. 2;

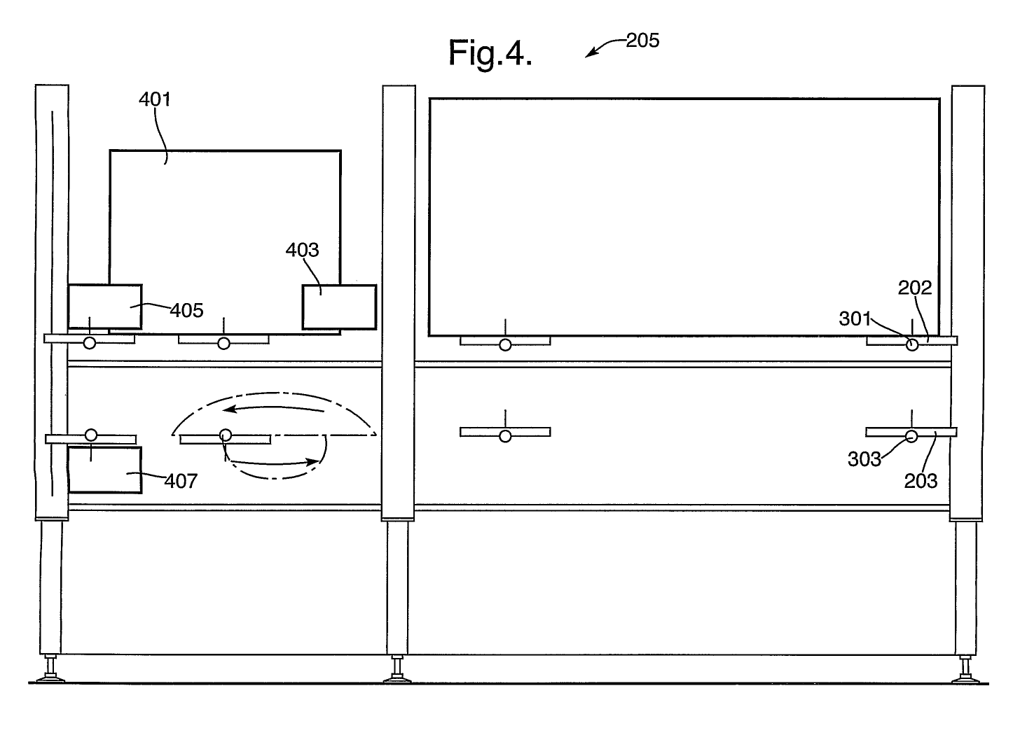

FIG. 4 is a schematic elevation view of the loading region;

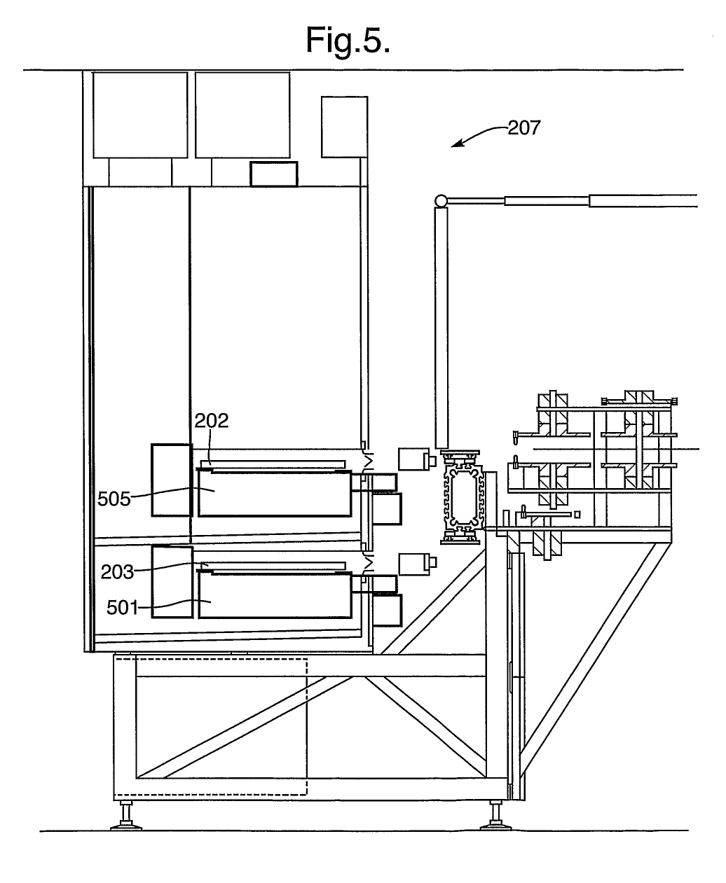

FIG. 5 is a sectional view of the developing region of the apparatus of FIG. 2;

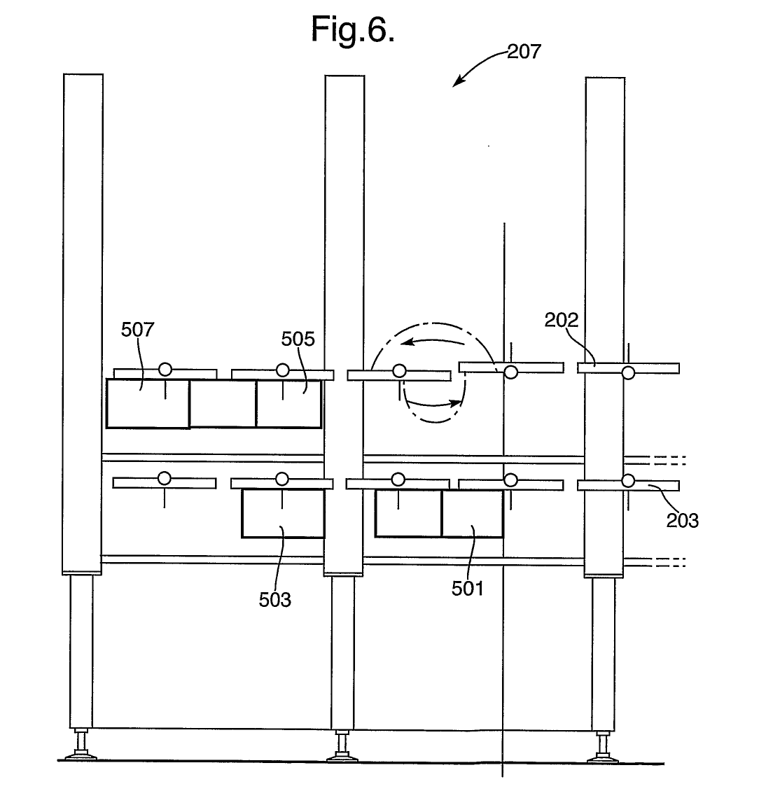

FIG. 6 is a schematic elevation view of the developing region;

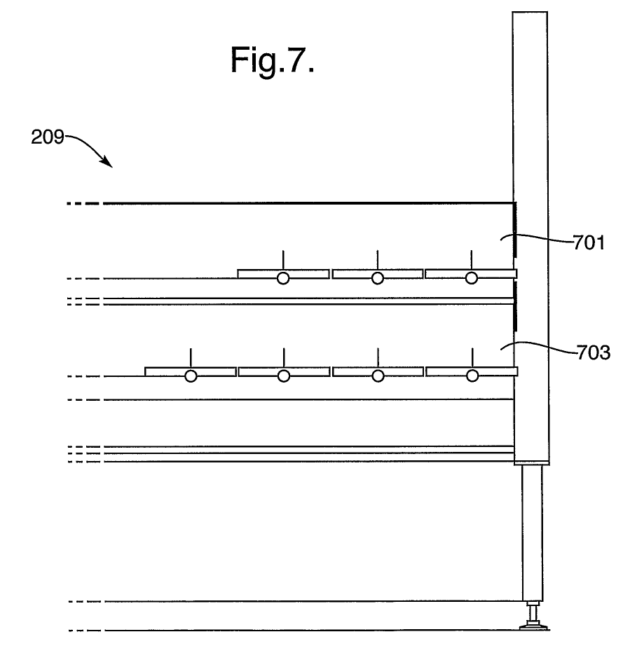

FIG. 7 is a schematic elevation view of the fusing region of the apparatus of FIG. 2;

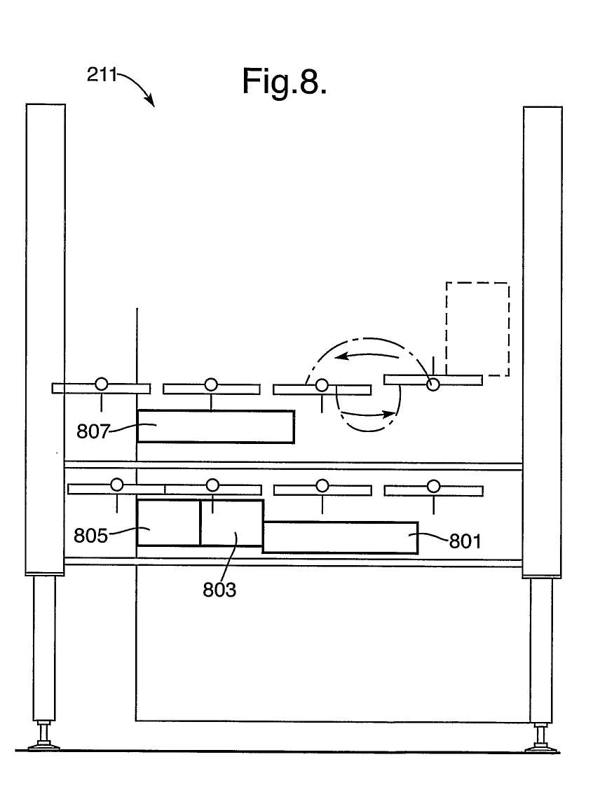

FIG. 8 is a schematic elevation view of the unloading region of the apparatus of FIG. 2;

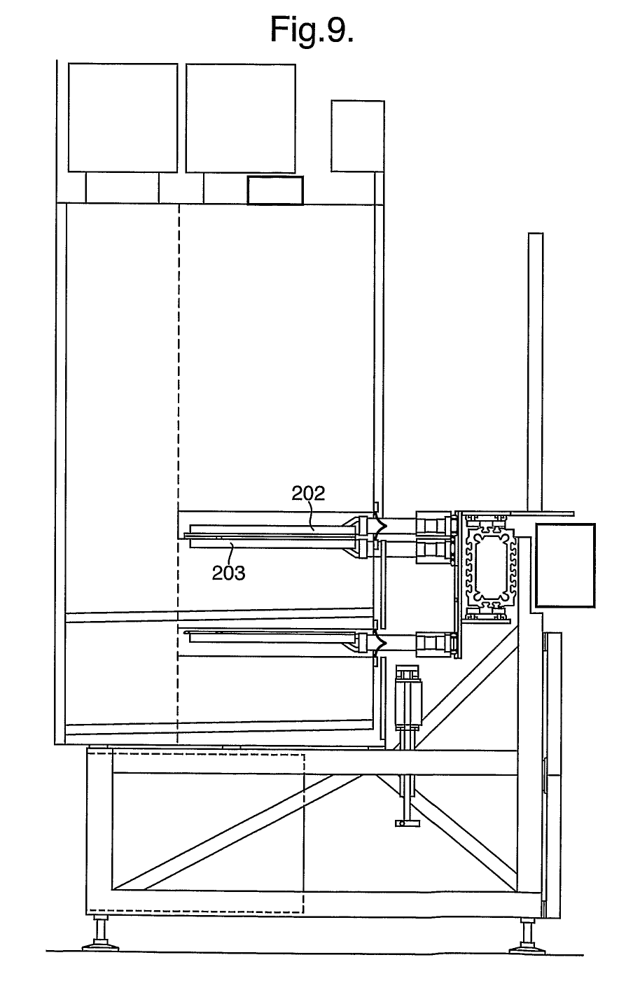

FIG. 9 is a sectional view of the transfer region of the apparatus of FIG. 2;

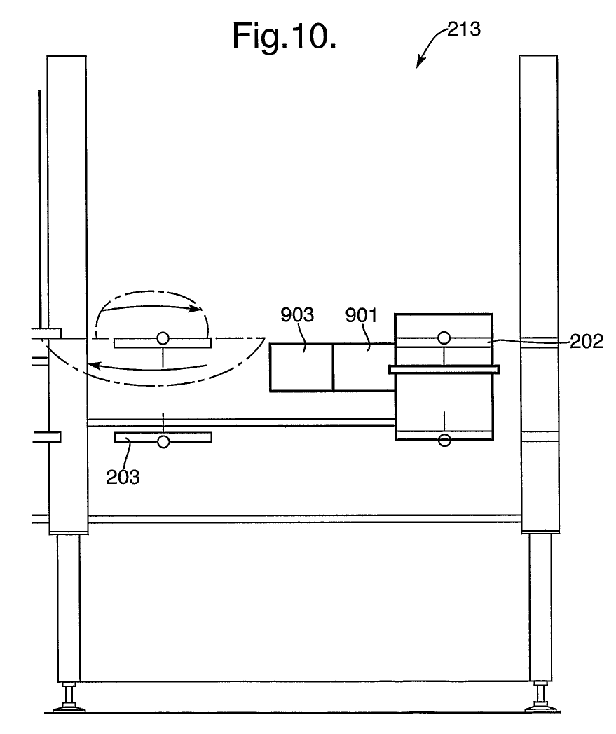

FIG. 10 is a schematic elevation view of the transfer region;

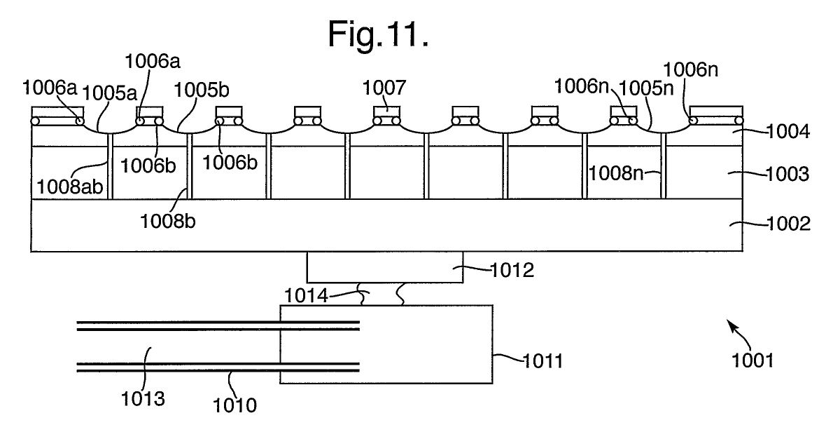

FIG. 11 is a sectional view of a platen used in the present invention; and

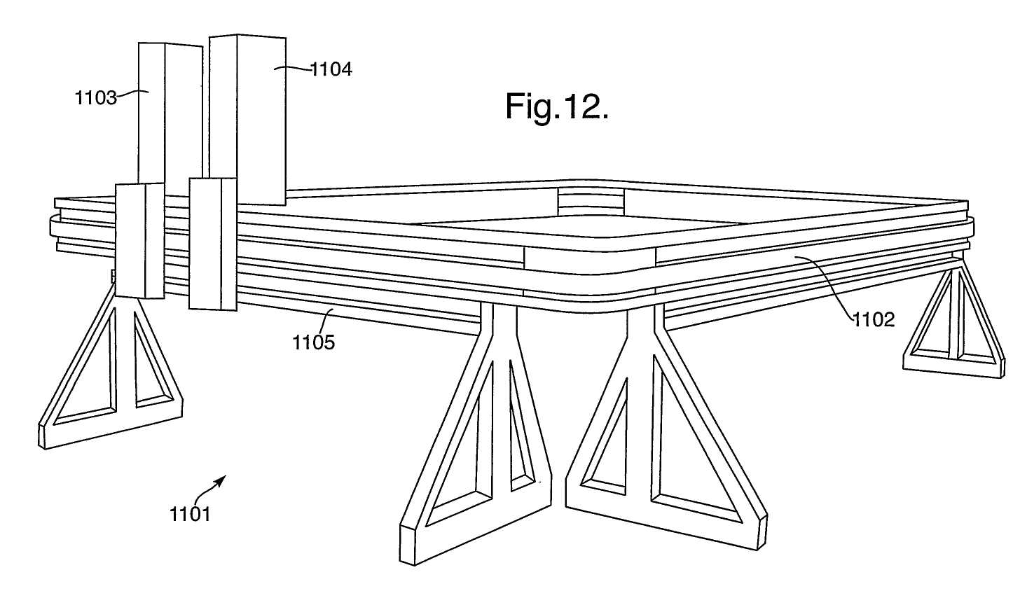

FIG. 12 is a schematic elevation view of the frame onto which the elements of the present invention are mounted.

FIG. 1a is a perspective view of a solid dosage form 101 which is to be coated in the coating apparatus of the present invention. In this example, the solid dosage form is a pharmaceutical tablet with a circumferential surface 102 and two domed end surfaces 103.

FIG. 1b is a perspective view of a solid dosage form 111 which is to be coated in the coating apparatus of the present invention. In this example, the solid dosage form is a pharmaceutical tablet with a circumferential surface 112 and two flat end surfaces 113 (only one of the surfaces 113 being visible in FIG. 1b). A chamfered portion 114 joins each of the flat end surfaces 113 to the circumferential surface 112.

Of course, the solid dosage forms described herein are just two of many possible solid dosage forms that could be used with the present invention. The solid dosage form could be any shape which is appropriate for its particular application.

FIG. 2 is a schematic plan view of the coating apparatus. The coating apparatus is generally designated 201 and incorporates apparatus for electrostatically applying a powder material to substrates. Two layers of platens 202, 203 are fixed to the apparatus and are arranged to rotate around the apparatus in a clockwise direction. (Note that, as FIG. 2 is a plan view, only the upper layer of platens is shown.)

The general operation of the apparatus is as follows. Solid dosage forms 101 or 111 are loaded into an upper platen 202 in the loading region, generally designated 205. The upper platen 202 passes adjacent an upper developer in the developing region, generally designated 207. In this region, the first side of each solid dosage form is coated with powder material. The powder material on the first side of each solid dosage form is then fused as the upper platen passes through the fusing region, generally designated 209. The upper platen passes unaffected through the unloading region, generally designated 211. The solid dosage forms are then transferred to a lower platen 203 in the transfer region, generally designated 213. The lower platen 203 passes unaffected through the loading region 205 (whilst the now empty upper platen 202 is being reloaded with uncoated solid dosage forms). The lower platen 203 passes adjacent a lower developer in the developing region 207 (whilst the upper platen 202 passes adjacent upper developer). In this region, the second side of each solid dosage form is coated with powder material. The powder material on the second side of each solid dosage form is then fused as the lower platen passes through fusing region 209 (whilst the upper platen 202 also passes through fusing region 209). The now fully coated and fused solid dosage forms are unloaded from the lower platen in the unloading region 211. In the transfer region 213, the half coated and fused solid dosage forms in the upper platen 202 are transferred to the now empty lower platen 203. The upper platen is then ready to receive new uncoated solid dosage forms in the loading region 205.

Thus, uncoated solid dosage forms enter the apparatus 201 at loading region 205. Fully coated and fused solid dosage forms exit the apparatus at unloading region 211. Each solid dosage form passes through approximately one and three quarter circuits of the apparatus between entry and exit.

Each lower platen is associated with an upper platen to which it is fixed and each pair of platens (along with associated mountings and so forth as described below) is termed a carriage. Although the two platens are free to rotate and to move relative to each other in the vertical direction, they are fixed in the horizontal direction so move around the apparatus together. Thus, operations are being carried out on the solid dosage forms in both platens simultaneously. For example, as each carriage passes through the fusing region, the coating on the solid dosage forms in the upper platen is being fused and the coating on the solid dosage forms in the lower platen is being fused simultaneously.

There is a single drive path for rotation around the apparatus, to which all the carriages are fixed. The carriages are independently driveable, however, so carriages may move at different speeds at different points on the drive path. Thus, the distance between carriages is not fixed. In the coating apparatus of FIG. 2, the carriages move at a first constant speed through the developing region 207, fusing region 209 and unloading region 211. When moving through the transfer region 213 and loading region 205, the carriage has three temporary stops; the remainder of the time through the transfer region and the loading region, the carriage moves at a second constant speed, which is greater than the first constant speed.

Various arrangements for driving the carriages are possible, in accordance with the invention. In one embodiment, each carriage is independently drivable under the control of a central controller. The central controller may communicate with each carriage via a wireless connection, for example, making use of the Bluetooth™ standard. In another, preferred, form of the invention, the carriages are divided into groups of six, with the lead carriage of the group of six being in wireless communication with a central controller. The other carriages in the group may obtain control information from the lead carriage. This is simpler than enabling all carriages to be able to communicate with the central controller.

One use of such a control system is to enable a controller to be pre-loaded with a number of programs, thereby enabling a variety of processes to be carried out, with an operator needing only to select the program required. Further, new programs can easily be written to enable new processes to be implemented and existing programs can be readily modified.

Each carriage obtains electrical power from a bus bar that is disposed around the apparatus. Each carriage includes a pick-up that is intended to be in contact with the bus bar at all times, although in preferred embodiments, the carriages will function if contact with the bus bar is lost because they are electrically interconnected by flexible cables and therefore able to share power. Each carriage is also connected to a central source of compressed air by a pipe that moves around the apparatus with the carriage. As discussed in detail below, a vacuum is sometimes required by the carriage. When a vacuum is required by a carriage, that vacuum is generated locally by means of a venturi vacuum pump that is driven by compressed air from the central source to which one or more carriages is connected. As noted above, control information may be transmitted to each carriage via a wireless link. Alternatively, control information may be transmitted between carriages via flexible cables.

By providing each carriage with a source of power, the means to locally generate a vacuum and control information, each carriage is able to operate entirely independent of the other carriages in the apparatus.

The exact location of a carriage may be determined at a number of predetermined points around the apparatus. By using a stepping motor, or a servo motor and encoder, the position of the carriage can be determined at all times, based on these known reference points. In one form of the invention, only one such reference point in provided, so that the exact position of each carriage is measured once per revolution of the apparatus, with the position at all other times being calculable from that measurement.

The movement of the carriage through the coating apparatus will be described more fully below.

Each region of the apparatus will now be described in more detail: the loading region is more fully described with reference to FIGS. 3 and 4, the developing region is more fully described with reference to FIGS. 5 and 6, the fusing region is more fully described with reference to FIG. 7, the unloading region is more fully described with reference to FIG. 8 and the transfer region is more fully described with reference to FIGS. 9 and 10. The platen itself is described with reference to FIG. 11. Finally, FIG. 12 shows the frame onto which the various regions of the apparatus are mounted.

FIG. 3 is a sectional view of the loading region 205 and FIG. 4 is a schematic elevation view of the loading region 205. Referring to FIGS. 3 and 4, upper platen 202 is fixed to an upper mounting 301 and lower platen 203 is fixed to a lower mounting 303. Upper 301 and lower 303 mountings are connected to a vertical bracket 305 which is connected to a drive system 307 which drives the pair of platens around the apparatus. As previously mentioned, each pair of platens, with associated mountings, bracket and drive system is termed a carriage.

Each carriage is attached to a source of compressed air, not shown in FIGS. 3 and 4. The compressed air is used in conjunction with a venturi vacuum pump to locally generate a vacuum supply. The vacuum supply is connected to each mounting 301, 303 such that, when the vacuum supply is switched on, the resulting pressure difference acts to attract the solid dosage forms towards the platens. Thus, when the vacuum supply is operating, the platens may be inverted, and the solid dosage forms will remain positioned on the platen. Of course, the local generation of a vacuum using a venturi vacuum pump is not the only way in which a vacuum supply can be provided. It is noted that however the vacuum supply is provided, in the preferred embodiments of the invention the vacuum pump on each platen is independently operable.

In one form of the invention, a central source of compressed air is provided with that compressed air being distributed by pipes to each of the carriages. The pipes are rotatably mounted about a central connection so that the pipes move around the central connection as the carriages move around the apparatus 201.

FIG. 3 shows the first section of the loading region, in which solid dosage forms 101 or 111 are supplied from a hopper 309 and are fed onto the upper platen 202 via first feeder 311. The operation in the first section of the loading region is as follows. The carriage moves into the first section of the loading region and, at a preselected position, there is a temporary carriage stop. While the carriage is stationary, the upper platen 202 moves vertically upward a short distance so that it is directly underneath the first feeder 311. First feeder 311 supplies sufficient solid dosage forms to fill the upper platen 202. The upper platen then moves vertically downward to its original vertical position. The carriage begins to move again. At this time, the upper platen 202 is gently vibrated to ensure that all the solid dosage forms are correctly positioned in the platen.

Referring to FIG. 4, it will be seen that the loading region also comprises a second section, in which the platens are checked and the upper platen reloaded if required via second feeder 401. The operation in the second section of the loading region is as follows. As the carriage moves into the second section of the loading region, the upper platen 202 is inspected by solid dosage form inspector 403. Simultaneously, the vacuum supply to the lower platen 203 is switched on and the lower platen is then inverted. The vacuum supply ensures that the half coated solid dosage forms remain on lower platen 203 when it is in its inverted orientation. At a preselected position, there is a temporary carriage stop. While the carriage is stationary, the upper platen moves vertically upward a short distance so that it is directly underneath second feeder 401. Second feeder supplies sufficient solid dosage forms to fill any gaps in the upper platen, which have been detected by the solid dosage form inspector 403. The upper platen then moves vertically downward to its original vertical position. The carriage begins to move again. At this time, the upper platen 202 is gently vibrated to ensure that all the solid dosage forms are correctly positioned in the platen. The vacuum supply to the upper platen is then switched on. As the carriage leaves the loading region 209, both platens are inspected once again by solid dosage form inspectors 405 and 407. Solid dosage form inspector 405 is above the upper platen. Solid dosage form inspector 407 is below the lower platen, as the lower platen is in its inverted orientation. Operation of the solid dosage form inspectors 403, 405 and 407 is described in more detail below.

From loading region 205, the carriages move towards the developing region 207.

FIG. 5 is a sectional view of the developing region 207 and FIG. 6 is a schematic elevation view of the developing region 207.

The coating of the solid dosage forms is achieved electrostatically and it is advantageous that the powder material supply be beneath each solid dosage form 101 or 111 so that the powder material has to move upwards towards the solid dosage form 101 or 111. Thus, the platens are in their inverted orientation (and the vacuum supply is operating) as they pass over the powder material supply.

The operation in the developing region is as follows. On entry to the developing region, the upper platen 202 is in it upright orientation, whereas the lower platen 203 is in its inverted orientation. (It will be remembered that the lower platen was inverted in the second section of the loading region 205.) As the carriage moves into the developing region 207, the upper platen 202 is inverted. Thus, at this point, both platens 202, 203 are in their inverted orientation, ready to pass over a powder material supply. Under normal operation, the upper platen contains a set of uncoated solid dosage forms and the lower platen contains a set of half coated and fused solid dosage forms with the uncoated sides now exposed for coating,

As the upper platen 202 is being inverted, the lower platen 203 passes over the developer units 501 and powder material is attracted from each developer unit 501 onto the exposed surface of the solid dosage forms in the lower platen 203. As the carriage moves on, the lower platen is inspected by solid dosage form inspector 503. The upper platen passes over developer units 505 and powder material is attracted from each developer unit 505 onto the exposed surface of the solid dosage forms in the upper platen 202. The upper platen is then inspected by solid dosage form inspector 507. Operation of the solid dosage form inspectors 503 and 507 is described in more detail below.

On the coating apparatus shown, there are two identical individual developer units at each level and each platen passes smoothly over each developer unit in succession. There may, of course, be a different number of developer units and this will depend on the particular application. In one form of the invention, a single developer unit is provided at each level. It should be noted that since the speed at which the carriages pass through the developer unit can be controlled, a longer developing period can be obtained by simply passing the carriage through the developer unit at a slow speed. Accordingly, the use of just one developer unit at each level will be adequate in many applications.

As previously mentioned, it is important with electrostatic application of powder material that the distance between the powder supply and the surface to be coated is accurately controllable as the distance between the powder material supply must be small enough to allow the powder material to “jump” onto the surface of the solid dosage form. Typically, this distance is of the order of 1.5 mm.

In order to achieve accuracy, the platens 202, 203 are fixed to the mountings 301, 303 but they are allowed to move relative to the mounting by a small distance in the vertical direction. At the developer unit, the drive path includes a guide (not shown) which may be a part of the developer unit and which fixes each platen at a selected vertical position for the duration of the coating process. That vertical position may be selected according to the actual required rate of powder supply for a given application. Thus, although the platens are substantially fixed in the vertical direction, this small freedom of movement ensures that accuracy can be achieved during the coating process. It also means that the actual powder supply surface distance is easily adjustable simply by adjustment of the guide.

Each developer unit is an independent unit which contains a supply of powder material. Each unit is designed so that portions of the unit which are “clean” (i.e. do not come into contact with powder material) are separate from portions of the unit which are “dirty” (i.e. do come into contact with the powder material and will therefore need regular cleaning). The “clean” portions are integral with the unit itself, whereas the “dirty” portions are located in a separate cartridge which is easily replaceable by the user.

From the developing region 207, the carriages move towards the fusing region 209. In the region between the developing region and the fusing region, both platens are rotated, in turn, back to their upright orientation, so that they are ready to pass through fusing region 209.

FIG. 7 is a schematic elevation view of part of fusing region 209. The fusing region comprises two fusing tunnels, an upper fusing tunnel 701 and a lower fusing tunnel 703. Each fusing tunnel comprises a heat source (typically a ceramic element, not shown) positioned on the inside upper surface of the fusing tunnel. It can be seen from FIG. 2 that the fusing region 209 occupies one entire side of the coating apparatus 201. As upper platen 202 passes along upper fusing tunnel 701, the powder material on the first side of the solid dosage forms in the upper platen is fused. As lower platen passes along lower fusing tunnel 703, the powder material on the second side of the solid dosage forms in the lower platen is fused. Thus, under normal operation, once the carriage has moved through entire fusing region 209, the solid dosage forms on upper platen 202 are coated and fused on one side and are ready to be coated and fused on the second side and the solid dosage forms on lower platen 203 are coated and fused on both sides and are ready to exit the apparatus.

The amount of the time and the temperature required for fusing will depend on the particular solid dosage form and powder material. Therefore, the platens may be raised or lowered in the fusing tunnels to alter the distance between the solid dosage forms and the heat source. Also, the temperature of the heat source may be changed. Also, the fusing tunnels may not extend for the full length of one side of the coating apparatus or part of the fusing tunnels may not include a heat source. Further, the temperature within the fusing tunnels need not be constant; a temperature profile within the fusing tunnel may be set up and may be controllable, for example by a remote controller. Various other changes may be made to the fusing region 209 to take account of different solid dosage forms and powder materials. In general, it has been found that the dimensions of the entire coating apparatus are often dependent on the size of the fusing region which is required for a given application.

It will be noted that, throughout the fusing region, the vacuum supply is operating for both upper and lower platens even though neither platen is in its inverted orientation. (It will be remembered that the vacuum supply for the upper platen was switched on as the carriage left the second section of the loading region and the vacuum supply for the lower platen was switched on as the carriage entered the second section of the loading region.) This is because it has been found that for some solid dosage forms, as the solid dosage form is heated in order to fuse the powder material, bubbles of gas are formed in the solid dosage form and those bubbles rise to the surface of the solid dosage form, and bubble through the partially fused powder material, causing an uneven surface effect on the resulting coated solid dosage form. In order to solve this problem, the vacuum supply is operating for both the lower and upper platen as the carriage moves through the fusing region. Then, as bubbles of gas form in the solid dosage form, they move towards the platen rather than towards the powder material which is being fused, thereby avoiding any bubbling of the powder material being fused and ensuring a smooth surface coating for the solid dosage form.

It has been found to be advantageous in some applications of the present invention to apply a relatively strong vacuum to the upper platen in the fusing region in order to reduce the problem associated with bubbles of gas forming in the solid dosage form. Furthermore, it has been found that it in some applications, it is not necessary to apply a vacuum to the lower platen in the fusing region as bubbles of gas do not tend to form when the platen passes through the fusing region 209 for a second time. By way of example only, in some applications it has been found that vacuum pressure in the region of 100 mbar is sufficient to retain solid dosage forms in the platen but that a vacuum pressure of 500 mbar might be appropriate when the upper platen is passing through the fusing region 209.

From fusing region 209, the carriages move towards the unloading region 211. In the region between the fusing region and the unloading region, the lower platen is inverted. As the vacuum supply for the lower platen is still operating, the solid dosage forms remain on the lower platen. Of course, if the vacuum supply is not operating when the lower platen passes through the fusing region 209, the vacuum supply should be turned on before the lower platen is inverted.

A cooling region (not shown) may be provided in the region between the fusing region 209 and the unloading region 211 in order to cool the solid dosage forms after they have passed through the fusing region. The cooling region may be implemented by blowing cool air at the solid dosage forms.

FIG. 8 is a schematic elevation view of the unloading region 211. The operation in the unloading region is as follows. As the carriage enters the unloading region, the upper platen 202 is inverted. As the vacuum supply to the upper platen is still operating, the solid dosage forms remain positioned on the upper platen. Under normal operation, the upper platen passes through the unloading region 211 without undergoing any further process steps. As the lower platen 203 (which is already in its inverted orientation) enters the unloading region, it passes over a lower conveyor 801. The vacuum supply for the lower platen 203 is then switched off and, as a result, the fully coated and fused solid dosage forms fall onto the lower conveyor 801. The lower platen is then gently vibrated to ensure that no solid dosage forms remain fixed to the lower platen. The lower platen is then brushed and vacuum cleaned by cleaner 803 and is then inspected by solid dosage form inspector 805. The lower platen should, at this point, be empty of solid dosage forms and be free from any excess powder material. Operation of the solid dosage form inspector 805 will be described in more detail below. From unloading region 211, the carriages move towards the transfer region 213. In the region between the unloading region 211 and the transfer region 213, the empty lower platen 203 is rotated again to return to its upright orientation.

As mentioned above, under normal operation, after the upper platen 202 is inverted, it passes through the unloading region 211 without undergoing any further process steps. However, the apparatus is adaptable so that, if it is necessary to unload solid dosage forms from the upper platen in this region (for example if the solid dosage forms are to be coated on one side only), this can be done in unloading region 211. In that case, as before, as the carriage enters the unloading region, the upper platen 202 is inverted. The upper platen then passes over an upper conveyor 807. The vacuum supply for the upper platen 202 is then switched off and, as a result, the solid dosage forms fall onto the upper conveyor 807. The upper platen is then gently vibrated to ensure that no solid dosage forms remain fixed to the upper platen.

The solid dosage forms which fall onto the upper or lower conveyor pass along the conveyor before falling into kegs. The solid dosage forms are checked (either manually or automatically), faulty solid dosage forms being directed into reject kegs and correct solid dosage forms being directed into product kegs. In the event that a problem occurs in the processing of a platen of solid dosage forms (for example, a vacuum failure, or inadequate heating in the fusing region), the whole platen of solid dosage forms may be rejected. Indeed, in some forms of the invention, it is only possible to either accept or reject the entire platen of solid dosage forms (rather than selecting which solid dosages forms are acceptable). The decision as to whether or not a platen of solid dosage forms should be accepted may be based entirely on process conditions so that there may be no means for checking the solid dosage forms at this processing stage.

FIG. 9 is a sectional view of the transfer region 213 and FIG. 10 is a schematic elevation view of the transfer region 213. Referring to FIG. 10, operation in the transfer region is as follows. The carriage moves into the transfer region and, at a preselected position, there is a temporary carriage stop. It will be remembered that, at this point, upper platen 202 is in its inverted orientation and lower platen 203 is in its upright orientation. While the carriage is stationary, the lower platen 203 moves vertically upward until it is in contact with or very close to upper platen 202. The vacuum supply for the upper platen 202 is then switched off and, as a result, the solid dosage forms fall the short distance onto the lower platen 203, so that their uncoated sides are now exposed. The vacuum supply for the lower platen 203 may be switched on so that the action of the vacuum assists in attracting the solid dosage forms towards the lower platen. The upper platen is gently vibrated to ensure that no solid dosage forms remain fixed to the upper platen. The lower platen 203 then moves vertically downward to its original vertical position. The carriage begins to move again. At this time, the lower platen 203 is gently vibrated to ensure that all the solid dosage forms are correctly positioned in the platen. The upper platen 202 is brushed and vacuum cleaned by cleaner 901 and is then inspected by solid dosage form inspector 903. The upper platen should, at this point, be empty of solid dosage forms and be free from any excess powder material. The solid dosage form inspector 903 will be described in more detail below.

It is clearly important that the upper and lower platens are accurately aligned when transferring solid dosage forms from the upper platen 202 to the lower platen 203. One scheme for achieving a sufficiently accurate alignment is to use a kinematic mount. As is well known, a kinematic mount is used to eliminate any or all of the six degrees of freedom (the straight X- Y- and Z-axes and the rotational axes of pitch, yaw and roll) between two elements of a system (the upper and lower platens in this case). Thus, by using a kinematic mount, it is possible to ensure that whatever the absolute positions of the upper and lower platens, they are extremely accurately positioned relative to one another.

As described above with reference to FIG. 8, it is possible for the upper platen 202 to be unloaded in unloading region 211. In that case, the upper platen 202 will enter the transfer region 213 empty and there will be no need to transfer solid dosage forms to lower platen 203. The upper platen can simply be brushed and vacuum cleaned by cleaner 901 and inspected by solid dosage form inspector 903.

As the carriage leaves the transfer region 213, the upper platen is rotated to return to its upright orientation.

From transfer region 213, the carriages move immediately into loading region 205 where the upper platen is fed with solid dosage forms once again by first tablet feeder 311.

From the description, it will be seen that there are three temporary carriage stops for each carriage in the transfer and loading regions, one in the transfer region and two in the loading region. Therefore, when the carriage is moving through these regions (rather than stationary), it moves at a higher speed than the speed at which it moved through the remaining regions of the coating apparatus, in order to compensate for the temporary carriage stops.

Operation of the solid dosage form inspectors 403, 405, 407, 503, 507, 805 and 903 is now described more fully. Inspectors in this sort of arrangement are well known and usually take the form of a camera or cameras positioned alongside each platen. If the platen should be full of solid dosage forms, the inspector can be arranged so that any missing solid dosage form results in a signal, which can, for example, trigger a subsequent feeder (e.g. second feeder 401 in FIG. 4) to provide a solid dosage form to the relevant position in the platen. Alternatively, if the platen should be empty, the inspector can be arranged so that any solid dosage form unintentionally on the platen results in a signal, which can, for example trigger a cleaner to clean the relevant position or provide an instruction to a user to replace the particular platen with a clean one.

It should be noted that it is not essential to provide as many solid dosage form inspectors as are described herein. For example, in one form of the invention, only two solid dosage inspectors are provided: solid dosage inspector 403 in the loading region and solid dosage inspector 903 in the transfer region.

The solid dosage form inspectors 403, 405, 407, 503, 507, 805 and 903 in the coating apparatus illustrated preferably use a light source that illuminates a row of solid dosage form positions and a camera positioned to take an image of the illuminated row. For each position, light from the light source is reflected to the camera in the absence of a solid dosage form, but is not reflected if a solid dosage form is present. In an alternative form of the invention, fibre-optic sensors are used rather than cameras. The fibre optic sensors are arranged to sense a variety of colours, which is useful if the coating apparatus is to be used with a variety of coatings and substrates. The sensors are preferably operable remotely regardless of whether cameras or fibre optic sensors are used.

Referring once again to FIG. 2, it will be seen that there are two vertical walls between the product region (i.e. the loading, developing, fusing, unloading and transfer regions) and the non product regions (i.e. the drive systems for the carriages and the other mechanics of the coating apparatus). The outer wall 215 divides the product region 219 from an annular chamber 221. The inner wall 217 divides the annular chamber 221 from the non-product region 223. The platens are located on the outside of the outer wall 215, the platen mountings pass through the outer and inner walls and the vertical bracket and drive system are located on the inside of the inner wall 217. The mountings pass through horizontal channels (not shown) in the inner and outer walls.

The inner and outer walls may be sealable (e.g. by flexible lips). In the event that the inner and outer walls are sealable using flexible lips, the horizontal channels allow the carriage to move around the circuit and the flexible lips prevent excess powder material or pollutants moving between the product region and the annular chamber. At appropriate points on the circuit, vertical channels (not shown), which are also sealable e.g. by flexible lips, are provided in order to allow the platens to move in the vertical direction.

The advantage of the arrangement is of vertical walls 215 and 217 is that the product and non product regions are entirely separate. This reduces the possibility that the solid dosage forms are contaminated (which is of particular importance in a pharmaceutical context). It also reduces the likelihood that the non-product regions will become excessively dirty from excess powder material and this will reduce cleaning and replacement costs. To further prevent any material passing between the product and non-product regions, the annular chamber is at an elevated pressure with a smooth air flow in the vertical direction.

Therefore, material is prevented from entering the annular chamber 221. The smooth vertical air flow may be generated using an air flow straightener, with the air being expelled at the bottom of the inner and outer walls in a horizontal direction. Access to the non-product region for engineers may be via a sealable crawl track under the apparatus or via a vertical ladder from above.

FIG. 11 is a sectional view of a platen, indicated generally by the reference numeral 1001, suitable for use in the present invention. The platen 1001 comprises an aluminium vacuum chamber 1002, an aluminium tool plate 1003 positioned on top of the vacuum chamber 1002 and a thin stainless steel mount plate 1004 positioned on top of the tool plate 1003. A number of hollows 1005a, 1005b . . . 1005n are provided in the mount plate 1004. An insulating washer 1006a, 1006b . . . 1006n is provided for each of the hollows in the mount plate 1004. A gold-plated stainless steel shield 1007 is provided on top of the mount plate 1004 and is separated from the mount plate by the insulating washers 1006a, 1006b . . . 1006n. A passageway 1008a, 1008b . . . 1008n connects each hollow 1005a, 1005b . . . 1005n in the mount plate 1004 to the vacuum chamber 1002.

The platen 1001 is attached to a carriage arm 1010 via an arm mount 1011 and a filter mount 1012. The carriage arm 1010 encloses a pipe 1013 which is connected to the vacuum supply for the platen. The arm mount 1011 and filter mount 1012 are provided with a connection 1014 that allows some movement of the platen relative to the carriage arm 1010.

The platen 1001 is connected via the carriage arm 1010 to a bracket (not shown) that is connected to a second platen arranged either above or below the platen 1001. The second platen is substantially identical to the platen 1001.

In use, a solid dosage form is provided in each of the hollows 1005a, 1005b . . . 1005n in the mount plate 1004. A vacuum can be supplied via pipe 1013, arm mount 1011, vacuum chamber 1002 and passageways 1008a, 1008b . . . 1008n, thereby retaining the solid dosage forms in the hollows in the mount plate 1004 when the platen is inverted. The mount plate 1004 is connected to ground potential so that charged powder is attracted to the solid dosage forms and the shield 1007 is maintained to a voltage potential such that powder material is not attracted to the shield itself.

As noted above, in use, solid dosage forms are retained in each of the hollows in the tablet mount 1004. The insulating washers 1006a, 1006b . . . 1006n electrically insulate both the solid dosage forms and the mount plate 1004 from the gold-plated stainless steel shield 1007. This enables the solid dosage forms to be connected to a ground potential and for the shield 1007 to be held at a different electrical potential. In this way, the platen can be arranged so that when charged powder is attracted to the earthed solid dosage forms in the developing region 207, powder is not attracted to the shield. The insulating washers 1006a, 1006b . . . 1006n also provide mechanical support to separate the mount plate 1004 and the shield 1007.

FIG. 12 is a schematic elevation of the frame onto which the elements of the present invention are mounted. As shown in FIG. 12, the frame, indicated generally by the reference numeral 1101 includes a track 1102 that forms an endless path. In the use of the frame 1101, a number of carriage assemblies are attached to the frame (only two are shown in FIG. 12). Further, process regions, such as the loading, developing, fusing, unloading and transfer regions described above, are located around the track 1102. An upper and a lower platen (not shown in FIG. 12) are attached to each of the carriage assemblies, such as assemblies 1103 and 1004. The non-product region 223 described above is located within the area enclosed by the track 1102. The product region 219 described above extended outwards from the track 1102. Accordingly, in use, both the inner wall 215 and the outer wall 217 (neither of which are shown in FIG. 12) are located within the area enclosed by the track 1102. The bus bar described above is generally indicated by reference numeral 1105.

It can be seen from FIG. 12 that the track assembly is a flexible structure, the dimensions of which can be readily altered, for example if additional process regions are required. By way of example, additional process regions might include a pre-treatment region, a printing region and a packaging region. Further, given that the algorithm that controls the process steps can be readily modified, process steps that are at present unidentified can be readily incorporated into the apparatus.

In one embodiment, the dimensions of the coating apparatus are as follows. The track length of the coating apparatus is about 20,000 mm (measured at the inner edge of the platens). The straight length of the coating apparatus is about 8,500 mm and the overall straight width of the coating apparatus is about 6,500 mm. The apparatus includes 36 carriages (i.e. 72 platens). The carriages move around the coating apparatus with an average speed of 40 mm/s, although the actual speed of the carriages at any particular time will vary, as described above. Each circuit of the apparatus takes each carriage about 500 s. Thus, when working under normal operation, the coating apparatus can produce about 400 platens of fully coated and fused solid dosage forms per hour. Typically, each platen will contain about 500 solid dosage forms. Thus, the coating apparatus can produce about 200,000 solid dosage forms per hour.

1-81. (canceled)

82. An apparatus for electrostatically applying a powder material to substrates, the apparatus comprising:
a plurality of platens arranged to move along an endless path, each platen being arranged to hold a plurality of substrates;
driving means for driving the platens along the endless path; and
an applicator assembly for applying the powder material to the substrates, the applicator assembly being located on a part of the endless path.

83. An apparatus according to claim 82 wherein the applicator assembly comprises at least one applicator having a supply of powder material and charging means for electrostatically charging the powder material.

84. An apparatus according to claim 83 wherein a portion of the applicator is replaceable by a user, the replaceable portion including the supply of powder material.

85. An apparatus according to claim 82 further including a fusing assembly for fusing powder material electrostatically applied to the substrates, the fusing assembly being located on a part of the endless path.

86. An apparatus according to claim 85 wherein the fusing assembly comprises a plurality of fusing devices disposed in series along the endless path.

87. An apparatus according to claim 82 further including a loading station for loading substrates onto the platens.

88. An apparatus according to claim 82 further including an unloading station for removing substrates from the platens.

89. An apparatus according to claim 82 further including a transfer station for transferring the substrates between platens.

90. An apparatus according to claim 82 further including at least one detector for inspecting the platens.

91. An apparatus according to claim 90 wherein the at least one detector comprises a plurality of optic fibres.

92. An apparatus according to claim 90 wherein the at least one detector comprises a camera.

93. An apparatus according to claim 90 wherein the detector is remotely operable.

94. An apparatus according to claim 82 wherein the driving means is arranged to drive the platens along the endless path at a plurality of speeds.

95. An apparatus according to claim 82 wherein each of said platens is independently drivable by said driving means.

96. An apparatus according to claim 82 further including a remote controller arranged to control the motion of the said platens.

97. An apparatus according to claim 96 wherein said remote controller communicates with at least some of said platens via a wireless link.

98. An apparatus according to claim 82 wherein the endless path is substantially horizontal.

99. An apparatus according to claim 98 further including a vertical partition separating the driving means from the platens, the driving means being located in a non-product region and the platens being located in a product region.

100. An apparatus according to claim 99 further including a second vertical partition separating the non-product region from the product region, the first and second vertical partitions defining a substantially annular chamber between the non-product region and the product region.

101. An apparatus according to claim 100 wherein the substantially annular chamber includes an air flow in the vertical direction.

102. An apparatus according to claim 98 wherein the platens are arranged to move along the endless path in pairs, one of the platens in the pair being located above the other platen in the pair.

103. An apparatus according to claim 102 wherein the platens in each pair are movable with respect to one another in the vertical direction.

104. An apparatus according to claim 102 wherein the applicator assembly for applying the powder material to the substrates comprises at least one upper applicator for applying the powder material to substrates in the upper platen and at least one lower applicator for applying the powder material to substrates in the lower platen.

105. An apparatus according to claim 104 wherein the upper and lower applicators are arranged to supply powder material to the substrates substantially simultaneously.

106. An apparatus according to claim 104 wherein the upper and lower applicators are arranged to supply powder material to the substrates sequentially.

107. An apparatus according to claim 102 further including a fusing assembly comprising an upper fuser for fusing powder material electrostatically applied to the substrates in the upper platen and a lower fuser for fusing powder material electrostatically applied to the substrates in the lower platen.

108. An apparatus according to claim 107 wherein the upper and lower fusers are arranged to fuse powder material on the substrates substantially simultaneously.

109. An apparatus according to claim 102 further including a transfer station for transferring substrates from the upper platen to the lower platen.

110. An apparatus according to claim 109 wherein the transfer station is arranged to move the platens relative to one another in the vertical direction such that a face of the lower platen is adjacent a face of the upper platen, the face of the upper platen holding a plurality of substrates, to shift the plurality of substrates from the face of the upper platen to the adjacent face of the lower platen and to separate the adjacent faces of the upper and lower platens.

111. An apparatus according to claim 109 wherein the transfer station includes at least one vibrator for vibrating one or both platens.

112. An apparatus according to claim 102 wherein powder is applied to a first portion of said substrates when said substrates are in the upper platen and wherein powder is applied to a second portion of said substrates when said substrates are in the lower platen, said second portion being on the opposite side of said substrates to said first portion.

113. An apparatus according to claim 82 wherein said plurality of platens are fixed to move along the endless path.

114. A method for electrostatically applying a powder material to substrates, the method comprising the steps of:
providing a plurality of platens arranged to move along an endless path, each platen being arranged to hold a plurality of substrates;
placing the substrates on the platens;
driving the platens in series along an endless path; and
electrostatically applying a powder material to the substrates on the platens.

115. A method according to claim 114 wherein the step of electrostatically applying a powder material comprises driving the platens past at least one applicator having a supply of powder and charging means for electrostatically charging the powder material.

116. A method according to claim 114 further comprising the step of fusing the powder material after it is electrostatically applied.

117. A method according to claim 116 wherein the step of fusing comprises driving the platens past a plurality of fusing devices disposed in series along the endless path.

118. A method according to claim 114 further comprising the step of removing the substrates from the platens after the powder material has been electrostatically applied.

119. A method according to claim 114 wherein the platens are arranged to move along the endless path in pairs, one of the platens in the pair being located above the other platen in the pair.

120. A method according to claim 119 further comprising the step of transferring the substrates from the upper platen to the lower platen.

121. A method according to claim 120 wherein the step of transferring the substrates between platens comprises vibrating one or both platens.

122. A method according to claim 114 further comprising the step of inspecting the substrates in the platens.

123. A method according to claim 122 wherein the substrates are inspected using one or more cameras.

124. A method according to claim 122 wherein the substrates are platens along the endless path comprises driving the platens simultaneously at a plurality of speeds.

125. A method according to claim 114 wherein each of said platens is independently drivable by said driving means.

126. A method according to claim 114 wherein the motion of each of said platens is controlled by a remote controller.

127. A method according to claim 126 wherein said remote controller communicates with at least some of said platens via a wireless link.

128. A method according to claim 114 wherein the endless path along which the platens are driven is substantially horizontal.

129. A method according to claim 114 wherein the substrates are pharmaceutical substrates.

130. A method according to claim 114 wherein the substrates are solid dosage forms.

131. A method according to claim 114 wherein the substrates are cores of pharmaceutical tablets.

132. A method of electrostatically applying a powder material to opposite faces of each of a plurality of substrates, the method comprising the steps of:
providing an upper platen and a lower platen, the upper platen being located vertically above the lower platen, each platen being arranged to hold a plurality of substrates;
providing a plurality of substrates on the upper face of the upper platen;
electrostatically applying powder material to exposed first faces of each of the plurality of substrates on the upper platen;
rotating the upper platen so that the plurality of substrates is located on the lower face of the upper platen;
moving the platens relative to one another in the vertical direction such that the upper face of the lower platen is adjacent the lower face of the upper platen;
shifting the plurality of substrates from the lower face of the upper platen to the upper face of the lower platen;
separating the adjacent faces of the upper and lower platens; and
electrostatically applying powder material to exposed second faces of each of the plurality of substrates on the lower platen.

133. A method according to claim 132 wherein the step of shifting the plurality of substrates from the lower face of the upper platen to the upper face of the lower platen includes vibrating one or both platens.

134. An apparatus for electrostatically applying a powder material to substrates, the apparatus comprising:
a plurality of pairs of platens arranged for movement about an endless horizontal path, each pair of platens comprising a lower platen and an upper platen located vertically above the lower platen, each platen being arranged to hold a plurality of substrates;
an applicator assembly for applying the powder material to the substrates, the applicator assembly being located on a part of the endless path; and
a transfer station for moving the platens relative to one another in the vertical direction such that the upper face of the lower platen is adjacent the lower face of the upper platen, the lower face of the upper platen holding a plurality of substrates, for shifting the plurality of substrates from the lower face of the upper platen to the upper face of the lower platen and for separating the adjacent faces of the upper and lower platens.

135. An apparatus according to claim 134 wherein the transfer station comprises a vibrator for vibrating the upper and/or lower platens.

136. An apparatus according to claim 134 wherein the applicator assembly comprises at least one upper applicator for applying the powder material to substrates in the upper platen and at least one lower applicator for applying the powder material to substrates in the lower platen.

137. An apparatus as claimed in claim 134 further including a kinematic mounting arrangement between the upper and lower platens to accurately control the position of the upper and lower platens relative to one another when the plurality of substrates are shifted from the lower face of the upper platen to the upper face of the lower platen.

138. An apparatus for electrostatically applying a powder material to substrates, the apparatus comprising:
a plurality of platens arranged to move along an endless path, each platen being arranged to hold a plurality of substrates;
an applicator assembly located on a part of the endless path for applying the powder material to substrates; and
driving means for driving the platens along the endless path, the driving means being arranged to drive platens simultaneously at a variety of speeds.

139. An apparatus according to claim 138 wherein each of said platens is independently drivable by said driving means.

140. An apparatus according to claim 138 further including a remote controller arranged to control the motion of the said platens.

141. An apparatus according to claim 140 wherein said remote controller communicates with at least some of said platens via a wireless link.

142. A method for electrostatically applying a powder material to substrates, the method comprising the steps of:
providing a plurality of platens arranged to move along an endless path, each platen being arranged to hold a plurality of substrates;
placing the substrates on the platens;
driving the platens in series along an endless path, each platen being independently driveable at a variety of speeds; and
electrostatically applying the powder material to the substrates on the platens.

143. A method according to claim 142 wherein each of said platens is independently drivable by said driving means.

144. A method according to claim 142 wherein the motion of each of said platens is controlled by a remote controller.

145. A method according to claim 144 wherein said remote controller communicates with at least some of said platens via a wireless link.

146. An apparatus for electrostatically applying a powder material to substrates, the apparatus comprising:
a plurality of platens arranged to move along an endless path, each platen being arranged to hold a plurality of substrates;
an applicator assembly located on a part of the endless path for applying the powder material to substrates; and
driving means for driving the platens along the endless path, wherein each of said platens is independently drivable by said driving means.

147. An apparatus according to claim 146 further including a remote controller arranged to control the motion of the said platens.

148. An apparatus according to claim 147 wherein said remote controller communicates with at least some of said platens via a wireless link.

149. A method for electrostatically applying a powder material to substrates, the method comprising the steps of:
providing a plurality of platens arranged to move along an endless path, each platen being arranged to hold a plurality of substrates;
placing the substrates on the platens;
driving the platens in series along an endless path, each platen being independently driveable by said driving means; and
electrostatically applying the powder material to the substrates on the platens.

150. A method according to claim 149 wherein the motion of each of said platens is controlled by a remote controller.

151. A method according to claim 150 wherein said remote controller communicates with at least some of said platens via a wireless link.

152. A carriage for conveying substrates along a path, the carriage comprising:
an upper platen for holding a plurality of substrates;
a lower platen for holding a plurality of substrates;
a bracket for supporting the upper and lower platen, the upper and lower platen being rotatably mounted on the bracket and being movable vertically with respect to one another; and
driving means for driving the carriage along the path.

153. A carriage according to claim 152 wherein, when the substrates are conveyed along the path by the carriage, the vertical separation of the upper platen and the lower platen is substantially preselected by a user, but the upper platen and/or the lower platen are free to move a small amount in the vertical direction.

154. A carriage according to claim 152 further including a kinematic mounting arrangement between the upper and lower platens, such that, on moving the upper and lower platens so that they are adjacent to one another, the relative positions of the upper and lower platens are accurately controllable.

155. An apparatus for electrostatically applying a powder material to substrates, the apparatus comprising:
a product region comprising a plurality of platens arranged to move along an endless path, each platen being arranged to hold a plurality of substrates and an applicator assembly located on a part of the endless path for applying the powder material to substrates;
a non-product region comprising driving means for driving the platens along the endless path; and
a partition separating the product region and the non-product region.

156. An apparatus according to claim 155 further comprising a second partition separating the product region and the non-product region, the two partitions defining an insulating chamber.

157. An apparatus according to claim 156 wherein the insulating chamber includes an air flow in a direction substantially parallel to the partitions.

158. An apparatus according to claim 155 wherein the endless path is substantially horizontal and the partition or partitions is/are substantially vertical.

159. A platen arranged to hold a plurality of substrates, the platen comprising:
a vacuum chamber for connection of the platen to a vacuum source;
an electrically conducting substrate mount having a plurality of hollows each suitable for receiving one of said plurality of substrates, wherein said substrate mount has a plurality of passageways therethrough, each passageway connecting one of said plurality of hollows to said vacuum chamber;
an electrically conducting shield having a plurality of holes aligned with the hollows in said substrate mount; and
an electrical insulator, positioned to electrically insulate said shield from said substrate mount, wherein, in the use of the platen, said electrical insulator electrically insulates said shield from said plurality of substrates.

160. A platen as claimed in claim 159 further including a tool plate located between said vacuum chamber and said substrate mount, said tool plate having a plurality of passageways therethrough aligned with the passageways of said substrate mount.

161. A platen as claimed in claim 159 further including a filter mount interposed between the platen and the vacuum source.

162. A platen as claimed in claim 159 wherein, in use, the platen is connected to the vacuum source via a carriage arm having a vacuum pipe therein.
